(19) United States
(12) Patent Application Publication
(10) Pub. No.: US 2009/0192774 A1
(43) Pub. Date: Jul. 30, 2009

(54) Engine transition test instrument and method

(76) Inventor: Yasunori Urano, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 10/585,409

(22) PCT Filed: Jan. 7, 2005
(86) PCT No.: PCT/JP05/00133

§ 371 Date: Jul. 7, 2006

(30) Foreign Application Priority Data
Jan. 9, 2004 (JP) 2004-004328

(51) Int. Cl. G06G 7/48

(52) U.S. Cl. 703/7

(57) ABSTRACT

A transition test on an engine is conducted by simulation using a simulation model of the engine, and a transition test on an actual engine is conducted using the control value. In the actual engine transition test, alteration of the control value by an ECU is efficiently carried out thereby to shorten the time required for the actual machine transition test. For the unaltered control value, the output from the actual ECU is used as it is. The output about the other control value is masked. Only for the examined and altered control value, the output from a virtual ECU is used to conduct the transition test.

### TECHNICAL FIELD

The present invention is used for a transition test of engines (internal combustion engines). In particular, the present invention relates to a transition test method used for adapting the transition characteristics and performance of diesel engines to the required performance objectives and a system for the same. The present invention is designed to quickly build an engine control system satisfying the transition performance objectives of an engine.

### BACKGROUND ART

The term “transition characteristics of an engine” refers not to characteristics obtained in the steady state, in which the rotational speed and torque remain constant, but to characteristics obtained in cases, in which they change with time. For instance, it refers to engine characteristics in states, in which the rotational speed etc. changes, such as during acceleration or during deceleration.

The measurement of output characteristics of a conventional engine, such as the torque output, exhaust gas, etc., in the transition states of the engine has been conducted using a technique, in which an actual engine is brought into the steady state, the output state of the engine is subjected to measurement, and the output of the engine is then estimated by substitution with transition state characteristics obtained by weighting the steady-state output data.

However, the measurement of steady-state engine characteristics has been a time consuming procedure in which after altering the control value of a controlled factor (e.g. the quantity of injected fuel, fuel injection timing, etc.) of an engine, one would wait until a predetermined time (e.g. 3 minutes) passes before the steady state is reached and then measure the output in this state, where one would alter the control value of one controlled factor, conduct measurements upon lapse of a predetermined time after reaching the steady state, and then again alter the control value of a controlled factor and conduct measurements, etc.

In an actual vehicle, during travel, the engine spends more time in a state of acceleration or deceleration and less time in a state permitting travel at a constant speed. For this reason, it is important to measure engine characteristics in transition states. In addition, in recent years, exhaust emissions regulations have been directed not at regulation based on the steady-state exhaust values of an engine, as was done before, but at regulation based on regulatory values related to the transition-state exhaust of an engine. Consequently, it has become important to measure transition characteristics that define what kind of transition state exhaust is obtained when certain alterations are made to certain controlled factors.

Even during steady-state characteristic measurement, which was conducted, as described above, in order to determine what kind of output would be obtained if alterations were made to the controlled factors of an engine in the steady-state, there were numerous controlled factors, with a particularly large number of controlled factors appearing when engine control was carried out by means of ECU-based electronic control, as a result of which the length of the test increased. For instance, parameters were added for various types of electronic control involved in engine control, such as EGR (Exhaust Gas Recirculation) valve control or VGT (Variable Geometry Turbo) control. During transition characteristic measurement, in a state in which the rotational speed and torque of the engine vary in the form of a time series, it is natural that the output data, likewise of the engine appear as data varying in the form of a time series, as a result of which the number of controlled factors increases and the length of the test grows exponentially if measurements are attempted in the steady state by altering the control values of every single controlled factor.

For this reason, technology has been proposed, in which engine control etc. is evaluated using simulation virtually reproducing the characteristics of the engine and the vehicle (see Patent Document 1).

In this technology a virtual vehicle model, complete with an engine, is created for each vehicle type in a simulator in advance, whereupon various control inputs, for instance, control values for the slot aperture, crank angle, and other controlled factors, are inputted into the vehicle model, and an attempt is made to estimate engine rotational speed, vehicle speed, and exhaust temperature sensor values as outputs of the virtual vehicle model based on the inputted control values.

Patent Document 1: JP H11-326135A

### DISCLOSURE OF INVENTION

### Problem to be Solved by the Invention

Because the number of controlled factors used in an engine has increased in recent years, when measurement of steady state and transition state characteristics is attempted in an actual machine, as described above, it takes a long time to obtain test data, which has become a bottleneck in engine development.

In addition, the technique consisting in deploying a vehicle model, including a virtual engine model, in a simulator and using it to observe the behavior of the engine is useful in terms of allowing for reductions in the length of engine development. However, in the above-described publicly known documents, the purpose is to build a simulation of a vehicle model and not to create a simulation of transition state phenomena in an engine and use it to evaluate required performance in the transition states of the engine. In addition, poor operability has been a problem in case of altering the control values of the respective controlled factors of an engine according to the transition state and estimating their results.

The present invention has been devised in consideration of these issues, and the objective thereof is to provide an engine transition test instrument and method that allow reduction of time required for the transition test of an engine and efficient alteration of the control values for the ECU. Accordingly, another objective of the present invention is to provide an engine transition test instrument and method that allow for reductions in the length of engine development.

### Means for Solving Problem

In general, when conducting an engine transition test, initially a simulation is performed using a simulated engine model. Specifically, control values are set to a virtual ECU (Electronic Control Unit or Engine Control Unit) that emulates an ECU that controls the engine, and control signals are supplied to the simulated model based on the control values. When control values with which the simulated model satisfies the objective performance are obtained, the control values are set to a actual ECU to conduct the transition test in an actual engine.

In such a simulation, there are a case in which the best mode is examined for the entire control values, and a case in which the best mode is examined for a part of the control values. Especially, in cases in which a conventional engine is improved to satisfy regulatory values required due to new exhaust emissions regulations, etc., in most cases, the best mode is examined for a part of the control values.

Accordingly, in the present invention, the transition test of an actual machine is conducted using the output from the actual ECU as is for the control values that have not been subjected to the examination and thus have not altered, and the output from the virtual ECU only for the control values that have been subjected to the examination and have been altered.

Specifically, according to the first aspect of the present invention, an engine transition test instrument is provided that includes virtual engine test means for simulating a transition state in which an engine rotational speed or torque changes with time, and actual machine transition test means for conducting an actual transition test using an actual engine and actual control means that controls that actual engine, wherein the virtual engine test means includes simulation means for simulating behavior of an engine by a transition engine model created based on data obtained by driving the actual engine while changing a value of at least one controlled factor, virtual control means that emulates the actual control means and supplies an engine control signal to the simulation means, and the actual engine transition test means includes means for switching to an engine control signal output from the virtual control means from a corresponding portion of an engine control signal output from the actual control means, and supplying a switched signal to the actual engine.

It is possible that the virtual engine test means further includes a control value operation means that supplies a control value for the controlled factor to the virtual control means, causes simulation results by the simulation means to be displayed on display means of an operator, and corrects the control value according to an operation by the operator.

The control program of the actual ECU (control means) is fixed and holds the control map predetermined with respect to the output values from the engine. Therefore, when the output values from the engine are changed as a result of altering a part of the control values, the actual ECU alters the control map. The objective of the simulation attempted here is to grasp the change in the output values from the engine caused by changing a part of the control values contained in one control map. Therefore, the objective of the simulation cannot be achieved if the control map is altered. Accordingly, it is necessary that a simulated output value obtained as if the output values from the engine had not changed is supplied to the actual ECU so as to avoid alteration of the control map. For that, it is preferable to include means for correcting an output value from the actual engine that has changed when an engine control signal output from the virtual control means was supplied to the actual engine to a value before such a change was made, and feeding back the corrected value to the actual control means.

According to the second aspect of the present invention, an engine transition test method is provided that includes a first step of creating a transition engine model based on data obtained by driving an actual engine while changing a value of at least one controlled factor in a transition state in which an engine rotational speed or torque changes with time, a second step of emulating actual control means that controls an actual engine, generating an engine control signal based on a control value set for the controlled factor, and operating the transition engine model as a virtual engine, and a third step of switching to an engine control signal generated in the second step from a corresponding portion of an engine control signal output from actual control means, and supplying the switched signal to an actual engine.

It is preferable that the second step is repeated while changing the control value, and the third step is performed when an output value from the virtual engine satisfies objective performance.

It is preferable that an output value from the actual engine that has changed when an engine control signal generated in the second step was supplied to the actual engine is corrected to a value before such a change was made, and the corrected value is fed back to the actual control means.

With the present invention, when conducting the transition test of an actual engine after the optimal control value is obtained through performing the examination by the simulation, the outputs from the actual ECU are used for the controlled factors that are not subject to the examination, and the output from the virtual ECU used for the simulation is used as an engine control signal with respect to the controlled factors that are subject to the examination. As a result, when rewriting the control values for the actual ECU after the completion of the transition test, only control values corresponding to a portion that has been subjected to a change, which enables efficient creation of the control software of the actual ECU.

In other words, with the present invention, it is possible to conduct a transition test in a transition state without replacing the steady-state test data, and quickly obtain the engine control value that satisfies the performance objective. In addition, by using the output from the actual ECU as is with respect to the control values that are not altered, the control value for the ECU can be altered with good efficiency. The present invention can reduce the time needed for engine development and can reduce the duration of product development.

Also, by generating a simulated engine output value and supplying the same to the actual ECU when supplying the output of the virtual ECU to an actual engine as the engine control signal, alteration of the control map of the actual ECU can be avoided, and it becomes possible to grasp the change in the engine output value due to the alteration in the control value of the virtual ECU, which contributes in improving or developing the ECU.

### BRIEF DESCRIPTION OF DRAWINGS

FIG. 1 is a diagram illustrating the system configuration of the present embodiment;

FIG. 2 is a flowchart illustrating the operation of the present embodiment;

FIG. 3 is a diagram for describing a switching unit of the present embodiment;

FIG. 4 is a diagram illustrating additional steps to the flowchart in FIG. 2;

FIG. 5 is a diagram for describing an example of data obtained in a transition state of the present embodiment;

FIG. 6 is a diagram illustrating measured values at an actual engine transition test of the present embodiment;

FIG. 7 is a diagram illustrating virtual measured values and target values of the present embodiment;

FIG. 8 is a diagram illustrating current control values and target control values of the present embodiment;

FIG. 9 is a diagram for describing the processes for changing a control value of the present embodiment; and

FIG. 10 is a diagram illustrating an example of other control values of the present embodiment.

### DESCRIPTION OF REFERENCE NUMERALS

1. Virtual Engine Test Instrument;
2. Model Creating Unit;
3. Virtual ECU;
4. Control Value Operating Unit;
5. Engine Simulating Unit;
6. Operator Terminal;
7. Virtual Response Creating Unit;
10. Actual Engine Transition Test Instrument;
11. ECU;
12. Engine;
13. Rotation Detector;
14. Measurement Unit;
15. Switching Unit; and
SW1 to SW6 Switches.

### BEST MODE FOR CARRYING OUT THE INVENTION

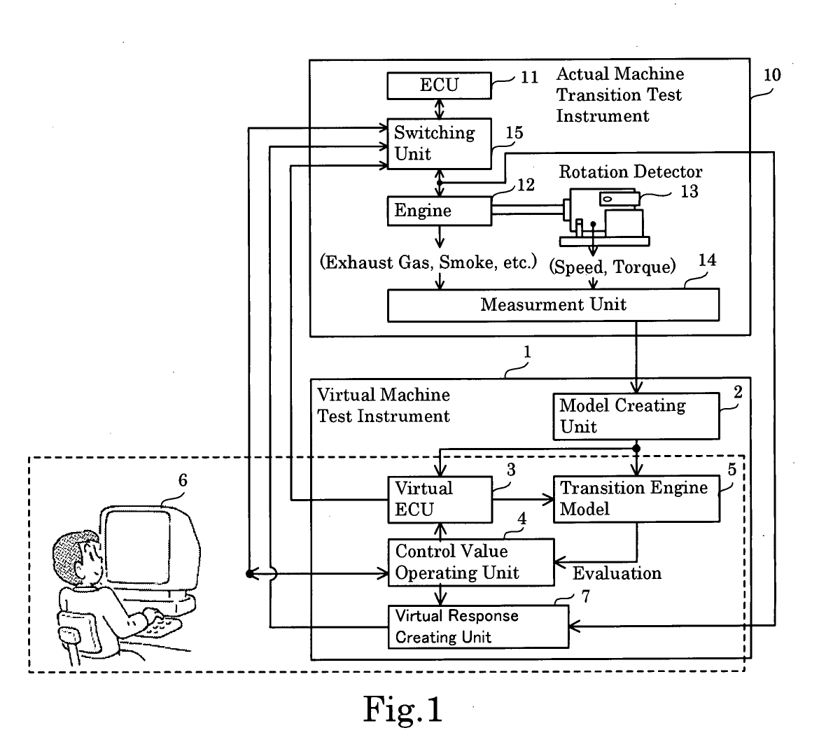

FIG. 1 is a block diagram of an engine transition test instrument of the present invention. The engine transition test instrument is provided with a virtual engine test instrument 1 that simulates transition states in which the engine rotational speed or torque changes with time, and an actual engine transition test instrument 10 that actually conducts a transition test using an actual engine 12 and an ECU 11 that controls the actual engine 12.

The virtual engine test instrument 1 is provided with an engine simulating unit 5 that simulates the behavior of the engine by a transition engine model created based on data obtained by driving the actual engine 12 while changing a value of at least one controlled factor, a virtual ECU 3 that emulates the ECU 11 and supplies engine control signals to the engine simulating unit 5, and a control value operating unit 4 that supplies control values for controlled factors to the virtual ECU 3, display the simulation results by the engine simulating unit 5 on an operator terminal 6, and corrects the control values according to the operation by an operator.

The actual engine transition test instrument 10 is provided with a rotation detector 13 used for detecting the rotational speed and torque of the crankshaft of the engine 12, and a measurement unit 14 used for measuring exhaust gas, smoke, and other parameters (fuel consumption, etc.) of the engine 12 as well as the rotational speed output from the rotation detector 13. The actual engine transition test instrument 10 is further provided with a switching unit 15 that switches to an engine control signal output from the virtual ECU 3, from the corresponding portion of the engine control signals output from the ECU 11, and supplies that switched engine control signal to the actual engine.

The virtual engine test instrument 1 also includes a model creating unit 2 that updates the transition engine model in the engine simulating unit 5 based on the test results obtained through the transition test of the engine 12, that is, the output from the measurement unit 14, and a virtual response creating unit 7 that corrects the output value from the engine 12 that has changed when the engine control signal output from the virtual ECU 3 was supplied to the engine 12, to a value before such a change was made, and feeds back the corrected value to the ECU 11.

The virtual engine test instrument 1 and the actual engine transition test instrument 10 may not be arranged adjacent to each other. For example, the actual engine transition test instrument 10 and the virtual engine test instrument 1 may be connected to each other using LAN. Further, the virtual engine test instrument 1 and the operator terminal 6 may not be arranged adjacent to each other, and they may be also connected to each other using LAN.

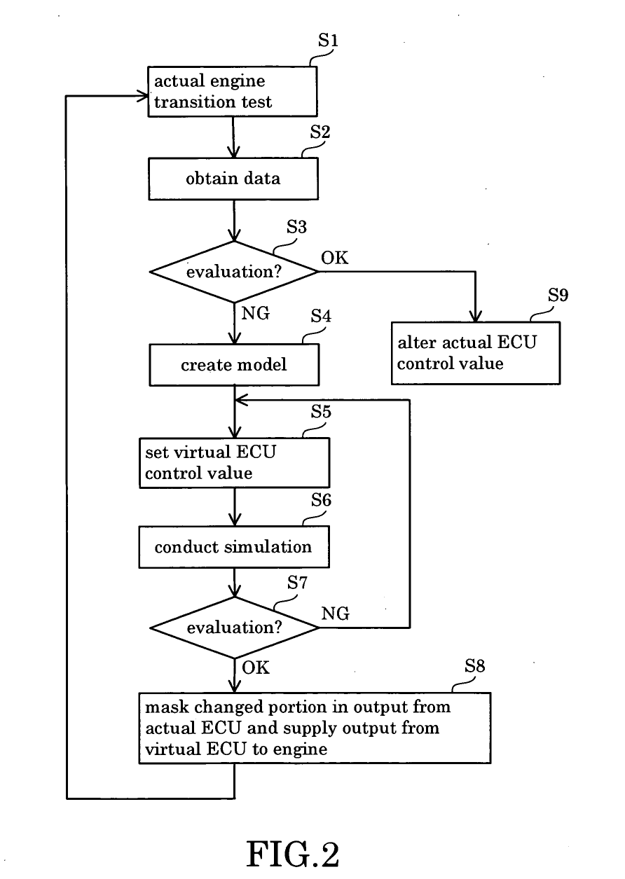

FIG. 2 illustrates a basic control flow of the engine transition test.

In order to conduct the engine transition test, initially, in the actual engine transition test instrument 10, the engine 12 is driven while changing the value of at least one controlled factor in the transition state in which the rotational speed or torque of the engine 12 changes with time (S1), and the measurement unit 14 obtains the resultant data (S2). A transition engine model is created in the model creating unit 2 using this data (S4), and a simulation is performed using the transition engine model as a virtual engine.

In this simulation, the transition engine model created in the model creating unit 2 is stored in the engine simulating unit 5, and the control value operating unit 4 sets to the virtual ECU 3 the control values for the controlled factors for operating the virtual engine constituted by the transition engine model (S5), and displays those control values on the operator terminal 6. The virtual ECU 3 emulates the ECU 11 that controls the engine 12, supplies engine control signals to the virtual engine in the engine simulating unit 5 based on the control values set by the control value operating unit 4, and performs the simulation (S6). The control value operating unit 4 displays the simulation results on the operator terminal 6, and the operator sees the display to determine whether or not the performance objectives are satisfied (S7). If the performance objectives are not satisfied, the control value operating unit 4 accepts correction of the control values from the operator terminal 6 (S5), and repeat the simulation (S6). The above processes are repeated until the simulation results satisfy the performance objectives.

When the performance objectives have been satisfied, the engine control signal output from the virtual ECU 3 is supplied to the engine 12 after being switched from the corresponding portion of the engine control signals output from the ECU 11 (S8), and the transition test is conducted on an actual engine (S1). The measurement unit 14 obtains the resultant data (S2), and confirms whether the required transition performance objectives are actually satisfied (S3). If satisfied, the control values of the ECU 11 is altered (S9). If not satisfied, the transition engine model is updated in the model creating unit 2 (S4), and the simulation is repeated.

The problem in this stage is that since the control program of the ECU 11 remains fixed unless it is confirmed that required transition performance objectives are actually satisfied, and holds the control map predetermined with respect to the output values from the engine 12. When the output values from the engine 12 are changed as a result of changing a part of the control values, the ECU 11 alters the control map. The objective of the simulation attempted here is to grasp the change in the output values from the engine caused by changing a part of the control values contained in one control map. Therefore, the objective of the simulation cannot be achieved if the control map is altered.

Accordingly, it is preferable that a simulated output value obtained as if the output values from the engine 12 had not changed so as to avoid alteration of the control map is supplied to the ECU 11. In the embodiment illustrated in FIG. 1, a virtual response creating unit 7 is provided in the virtual engine test instrument 1, in which the output value from the engine 12 that has changed by supplying the engine control signal output from the virtual ECU 3 to the engine 12 is corrected to an output value before such a change was made, which is supplied to the ECU 11.

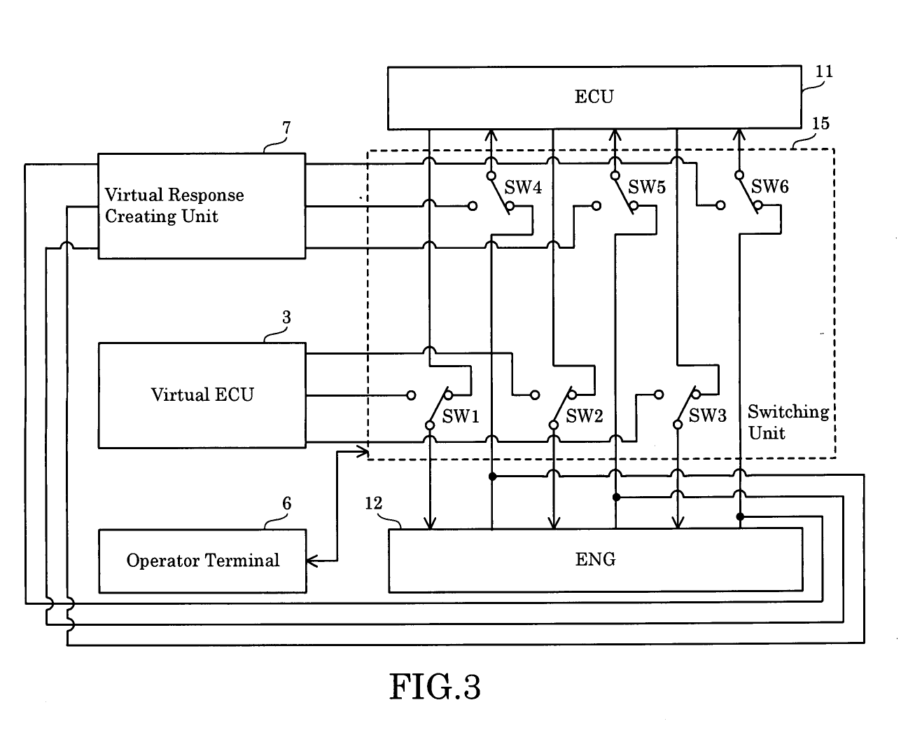

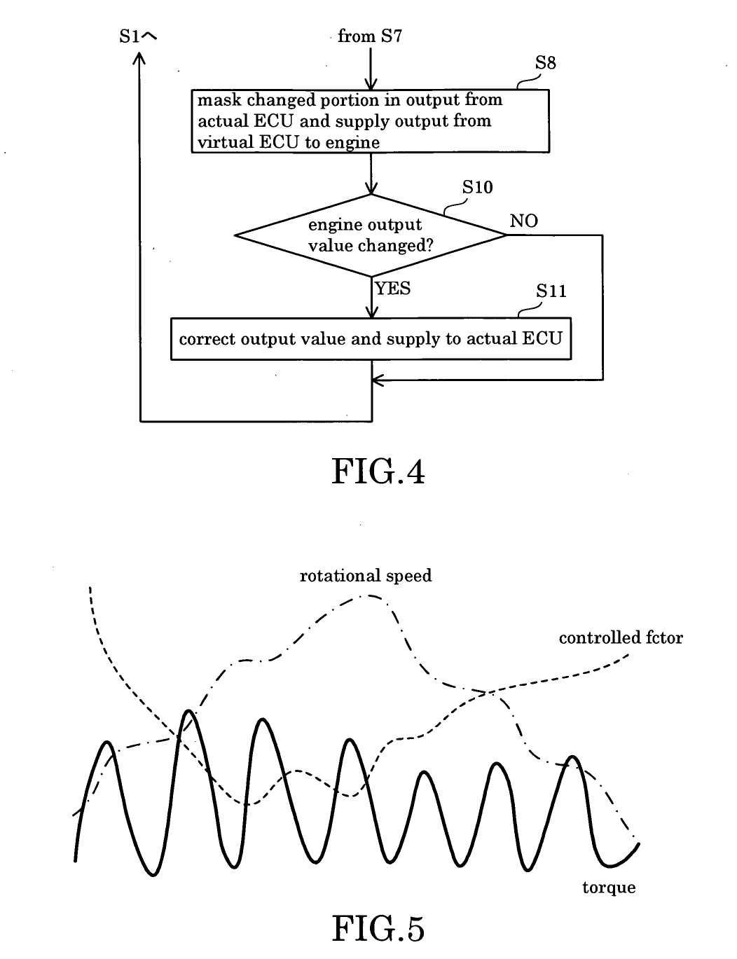

FIG. 3 illustrates an example of the configuration of a switching unit 15 that includes the configuration to supply the output from the virtual response creating unit 7 to the ECU 11. FIG. 4 illustrates additional steps in providing the output from the virtual response creating unit 7 to the ECU 11.

Specifically, after step S8 described with reference to FIG. 2, if there is a change in the output value from the engine (S10), such a change in the output value is corrected by the virtual response creating unit 7, and a simulated output value obtained as if the output value from the engine 12 had not changed, is supplied to the ECU 11 (S11).

The switching unit 15 shown in FIG. 3 is provided with the ECU 11, the engine 12, the virtual ECU 3, switches SW1 to SW6 connected to the virtual response creating unit 7 and the operator terminal 6. Switches SW1 to SW3 respectively switch the connection between the virtual ECU 3 and ECU 11 with the engine 12 for each control value or output value. Switches SW4 to SW6 respectively switch the connection between the virtual response creating unit 7 and the ECU 11 with the engine 12 for each output value.

In the example of FIG. 3, six switches SW1 to SW6 are provided. However, the number of switches varies as appropriate depending on the number of the control values or output values. The control values are, for example, EGT control values and VGT control values. The output values are output values from the respective sensors that the ECU 11 can directly obtain from the engine 12, and includes, for example, output values indicating water temperature, air pressure and boost pressure.

For example, assume a case where the EGR value is changed and the change in the output value from the engine 12 due to such a change is examined. Then, it is assumed that the virtual ECU 3 supplies the EGR value to the engine 12 via the switch SW1. The operator switches the switch SW1 to the side of the virtual ECU 3 by the operator terminal 6, and at the same time switches the switches SW4 to SW6 to the side of the virtual response creating unit 7.

As a result, the EGR value changed is supplied to the engine 12 by the virtual ECU 3. Accordingly, water temperature, air pressure or boost pressure, etc. as outputs from the engine 12 may change. In such a case, the virtual response creating unit 7 compensates such a change, and supplies to the ECU 11 via switches SW4 to SW6 output values obtained as if such a change had not occurred. Subsequently, the ECU 11 does not recognize the change in the output value from the engine 12, and does not alter the control map. Thus, the simulation results can be obtained for a case in which a part of the control values in the existing control map is altered.

An example of data obtained from an actual engine in the transition state is briefly described with reference to FIG. 5. As shown in FIG. 5, transition driving is performed in which the rotational speed (alternate long and short dash line) and torque (solid line) change every second. At this time, the controlled factor of the ECU 11 is supplied to the engine 12 as shown by the dashed line. These rotational speed, torque and controlled factor are respectively recorded and displayed in the graph shown in FIG. 5. If delay is present between the change in the controlled factor and the change in the rotational speed and torque, they can be recorded and displayed after compensating such delay. As a result, the change in the rotational speed and torque corresponding to the change in the controlled factor can be expressly shown.

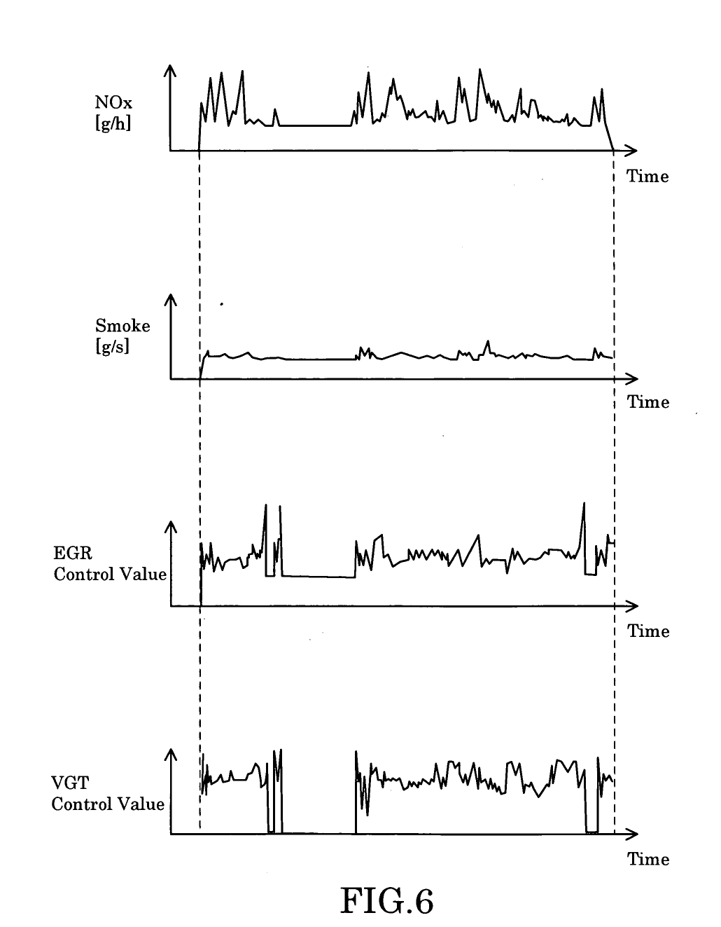

As a specific example, EGR and VGT are assumed as the controlled factors for which setting is altered, the number of gram per hour (g/h) of NOx and the number of gram per second (g/s) of smoke are assumed as the index for the performance objectives. Their relationship is illustrated in FIG. 6. The EGR control value and the VGT control value are set to the ECU 11, based on which the engine 12 is controlled. While the rotation detector 13 measures the rotational speed and torque and the measurement unit 14 takes in the resultant data, the measurement unit 14 measures the amount of NOx and smoke emitted by the engine 12. The model creating unit 2 creates a model based on the measurement results, and stores the model in the engine simulating unit 5. Then, the simulation according to the above-described processes is started.

Here, the control values which should be altered do not extend to the control values involving all the controlled factors that the ECU 11 controls, but to the control values involving a part of the controlled factors, or a part of the control value that changes with time.

If a part of the control values would be altered, the control values for other controlled factors would not be altered. Therefore, among the engine control signals output from the ECU 11, the control signals involving the EGR control and the VGT control are masked. Instead of the masked control signals, the engine control signals output from the virtual ECU 3 are supplied to the engine 12.

In order to correct the control values set to the virtual ECU 3, the operator operates the control values displayed in a graph on the operator terminal 6 with mouse dragging. The control value operating unit 4 is notified of the operation condition at this time from the operator terminal 6, and the control value operating unit 4 then obtains a new control value and displays the same on the operator terminal 6. Accordingly, the control values can be altered while visually confirming the change of the graph shape.

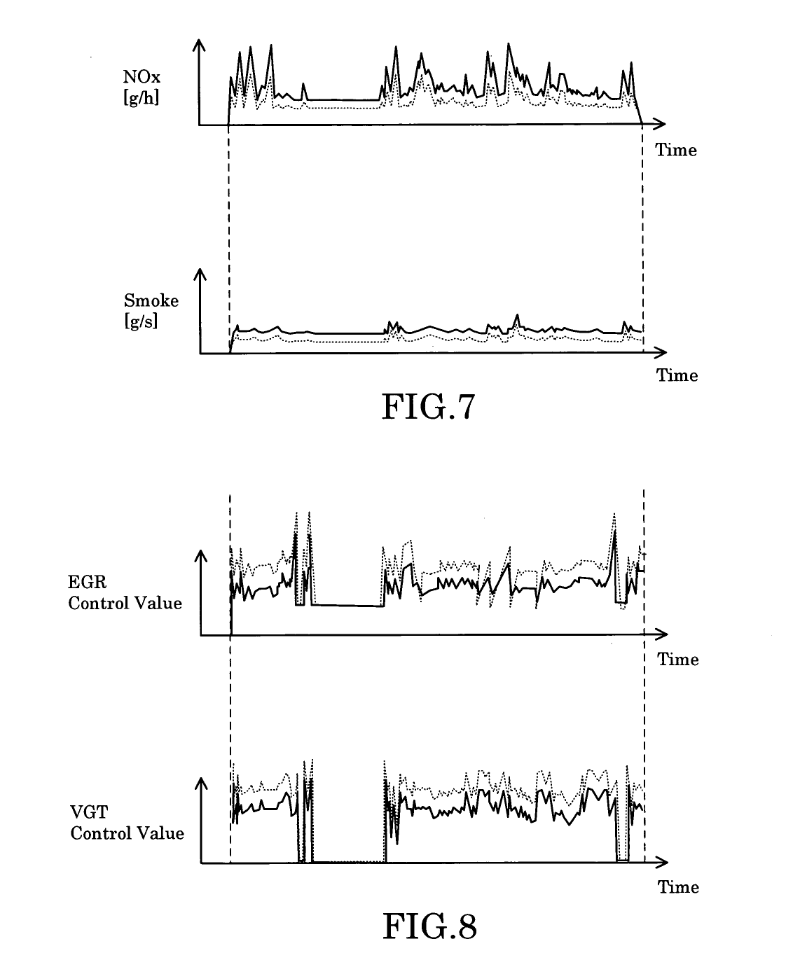

The target value for the simulation can be displayed in parallel with the simulation result. FIG. 7 shows an example of such a display. In this example, the simulation results (virtual measured value) of NOx and smoke are indicated by the solid line, and their target values are indicated by the dotted line. The operator determines if the difference between the virtual measured value and the target value is within the permissible limits. When the difference exceeds the limits, the operator corrects the control value so as to approximate the virtual measured value to the target value.

With respect to correction of the control values as well, it is preferable that the control value before and after correction are displayed in parallel. FIG. 8 shows an example of such a display in which the control value before correction is indicated by the solid line, and the control value after correction is indicated by the dotted line.

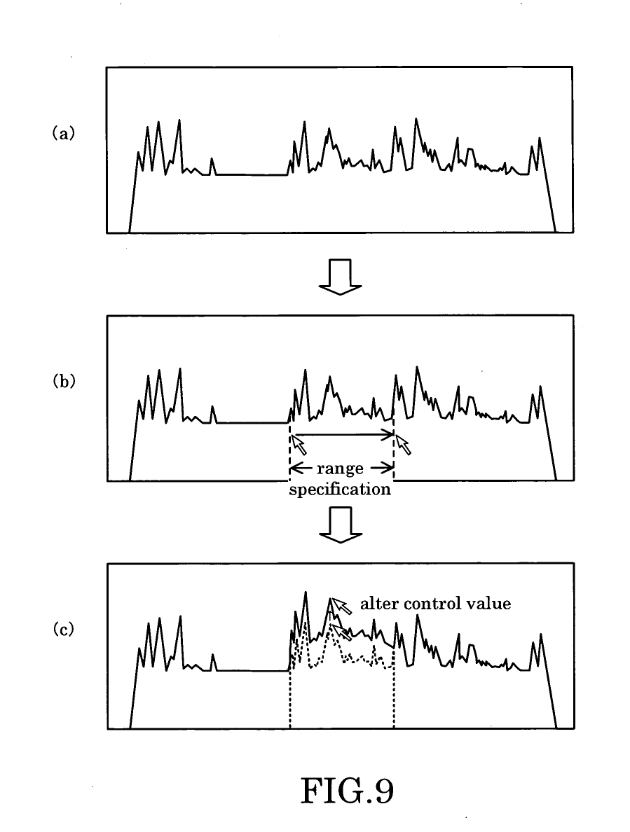

FIG. 9 illustrates an example of the operation for correcting the control values. First, with respect to the graph showing the current control values shown in FIG. 9(a), the range subject to alteration is specified in the lateral direction of the screen. This range is specified by dragging the pointer on the screen in the lateral direction by operating the mouse, as shown in FIG. 9(b). Subsequently, an increase/decrease extent of the alteration is specified in the vertical direction of the screen. This increase/decrease extent is specified by dragging the pointer on the screen in the vertical direction by operating the mouse, as shown in FIG. 9(c).

In addition to the correction of the control values by changing the graph shape, correction can be made also by inputting the control values directly from the operator terminal 6.

Control values corrected as described above are supplied to the virtual ECU 3 again, and the simulation is performed by the engine simulating unit 5.

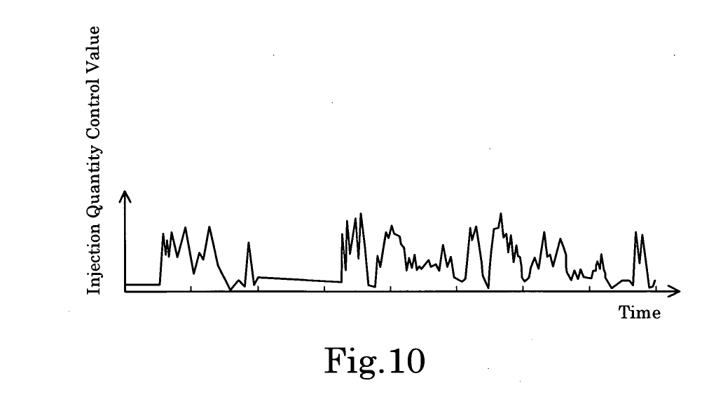

In the above description, the EGR control value and the VGT control value were used as examples of the controlled factor. However, the above description is also possible with other controlled factors. For example, as illustrated in FIG. 10, the control value of the quantity of injected fuel corresponding to the transition state of NOx and smoke illustrated in FIG. 7 can be used for the description.

As described so far, according to the present invention, it is possible to conduct the transition test in the transition state without replacing steady-state test data, and quickly obtain the engine control values that satisfy performance objectives. In addition, with respect to the unaltered control values, the output from the actual ECU can be used as is, and it is possible to alter the control values of the ECU with good efficiency. The present invention can reduce the time needed for engine development and can reduce the duration of product development.

### INDUSTRIAL APPLICABILITY

The virtual engine test instrument 1 in the foregoing embodiment, especially, the virtual ECU 3, the control value operating unit 4, the engine simulating unit 5 and the virtual response creating unit 7 can be implemented with a general information processing system. The present invention can be implemented as a computer program that realizes the above units when installed on a general information processing system. Further, the present invention can be implemented as a storage medium on which such a computer program is stored that is readable by information processing systems.

1. An engine transition test instrument comprising:
virtual engine test means for simulating a transition state in which an engine rotational speed or torque changes with time; and
actual engine transition test means for conducting actual transition tenting using an actual engine and actual control means that controls that actual engine,
wherein the virtual engine test means comprises
simulation means for simulating behavior of an engine by a transition engine model created based on data obtained by driving the actual engine while changing a value of at least one controlled factor;
virtual control means that emulates the actual control means and supplies an engine control signal to the simulation means; and
the actual engine transition test means comprises means for switching to an engine control signal output from the virtual control means from a corresponding portion of an engine control signal output from the actual control means, and supplying a switched signal to the actual engine.

2. The engine transition test instrument according to claim 1, wherein the virtual engine test means further comprises a control value operation means that supplies a control value for the controlled factor to the virtual control means, causes simulation results by the simulation means to be displayed on display means of an operator, and corrects the control value according to an operation by the operator.

3. The engine transition test instrument according to claim 1, wherein the actual control means is configured so as to perform feed back control with referencing an output value of the actual engine and the instrument comprises means for correcting an output value from the actual engine that has changed when an engine control signal output from the virtual control means was supplied to the actual engine to a value before such a change was made, and feeding back the corrected value to the actual control means.

4. An engine transition test method comprising:
a first step of creating a transition engine model based on data obtained by driving an actual engine while changing a value of at least one controlled factor in a transition state in which an engine rotational speed or torque changes with time;
a second step of emulating actual control means that controls an actual engine, generating an engine control signal based on a control value set for the controlled factor, and operating the transition engine model as a virtual engine; and
a third step of switching to an engine control signal generated in the second step from a corresponding portion of an engine control signal output from actual control means, and supplying the switched signal to the actual engine.

5. The engine transition test method according to claim 4, wherein the second step is repeated while changing the control value, and the third step is performed when an output value from the virtual engine satisfies objective performance.

6. The engine transition test method according to claim 4, wherein an output value from the actual engine that has changed when an engine control signal generated in the second step was supplied to the actual engine is corrected to a value before such a change was made, and the corrected value is fed back to the actual control means.

7. A computer program that realizes, by being installed on an information processing system,
first means for creating a transition engine model based on data obtained by driving an actual engine while changing a value of at least one controlled factor in a transition state in which an engine rotation speed or torque changes with time;
second means for emulating actual control means that controls an actual engine, generating an engine control signal based on a control value set for the controlled factor, and operating the transition engine model as a virtual engine; and
third means for switching to an engine control signal generated in the second step from a corresponding portion of an engine control signal output from actual control means, and supplying the switched signal to the actual engine.

8. A storage medium that is readable with an information processing system on which the computer program according to claim 7 is stored.
